(19) United States
(12) Patent Application Publication
(10) Pub. No.: US 2008/0288958 A1
(43) Pub. Date: Nov. 20, 2008

(54) Near Field Communication Host Controller Interface

(76) Inventors: Seung Hyup Ryoo, Seoul (KR); Sang Cheol Min, Seoul (KR); Byoung Wook Lee, Seoul (KR); Jin Tae Kim, Seoul (KR)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 12/092,788

(22) PCT Filed: Nov. 7, 2006
(86) PCT No.: PCT/KR2006/004647

§ 371 Date: May 6, 2008

Related U.S. Application Data
(60) Provisional application No. 60/733,796, filed on Nov. 7, 2005.
(60) Provisional application No. 60/756,562, filed on Jan. 6, 2006.
(60) Provisional application No. 60/763,923, filed on Feb. 1, 2006.
(60) Provisional application No. 60/771,872, filed on Feb. 10, 2006.
(60) Provisional application No. 60/787,633, filed on Mar. 31, 2006.
(60) Provisional application No. 60/795,642, filed on Apr. 28, 2006.

(51) Int. Cl. G06F 9/54

(52) U.S. Cl. 719/313; 719/321

(57) ABSTRACT

Provided is a communication interface between an NFCH and an NFC device and a method for controlling an NFC HCI. In the method, a command message is transmitted from the host to the device. The command message includes one of recording data, reading data of the device, requesting the device to transmit predetermined data, and setting the device. A response message informing a performance result of a relevant command is transmitted from the device to the host in response to the command message. After that, an event message is transmitted from the device to the host when needed.

### TECHNICAL FIELD

The present invention relates to a communication interface between a near field communication (NFC) host and an NFC device.

BACKGROUND ART

Universality and compatibility regarding a communication interface between an NFC host and an NFC device or an NFC chipset are required. An interface between a host such as an MSM chip of a mobile handset and a micro controller unit (MCU) of a mobile apparatus, and a device or a chipset connected to the host should be handled with great importance.

FIG. 1 illustrates interfaces between various NFC host (NFCH) and various NFC devices or NFC chipsets (NFCC). An interface between an NFCH A 110 and an NFCC A 210 is connected to an upper layer 111 on the basis of a relevant driver interface 112 suitably realized for a driver A 113 connected to the NFCC A 210 via a serial bus. An interface between other NFCH B 120 and other NFCC B 220 is connected to an upper layer 121 on the basis of a relevant driver interface 122 suitably realized for a driver B 123 connected to the NFCC B 220 via a serial bus. An interface between another NFCH C 130 and another NFCC 230 is connected to an upper layer 131 on the basis of a relevant driver interface 132 suitably realized for a driver C 133 connected to the NFCC C 230 via a serial bus.

Referring to FIG. 1, for a predetermined host, a device or a chipset connected to the predetermined host establishes a relevant driver interface using a driver suitably realized for the device or the chipset. Therefore, interfaces between the host and the chipset or the device are different from each other, and do not guarantee mutual compatibility or universality.

FIG. 2 illustrates disadvantages that can be generated in the case where mutual compatibility or universality is not guaranteed in interfaces between a host and a chipset or a device. When an interface suitable for the NFCC 210 is established with respect to a predetermined NFCH 100, other NFCCs 220 and 230 cannot be connected to the host 100 on the basis of different drivers 123 and 133.

### DISCLOSURE OF INVENTION

### Technical Problem

When interfaces between a host and a device or a chipset connected to the host are different for each host, each device, or each chipset, mutual compatibility or universality is not guaranteed.

As described above, referring to FIG. 2, a control interface between different devices requiring different interfaces requires design and development of a new driver and a new driver interface suitable for each host and each device, and requires mounting of the driver and the driver interface within the device not only in an aspect of a host but also in an aspect of the device or the chipset.

An object of the present invention is to define an interface between a host and a device or a chipset connected to the host, and to conform to the defined interface, thereby guaranteeing universality and compatibility to a host controller interface between different devices.

Another object of the present invention is to define a data format for transmitting data between an NFCH and an NFC device or an NFC chipset, and a process of the data format, and to provide an interface between devices by conforming to the defined format and the process thereof, thereby guaranteeing universality and compatibility to a host controller interface between different devices.

### Technical Solution

To achieve these and other advantages and in accordance with the purpose of the present invention, as embodied and broadly described, there is provided a communication method between a host and a device in a communication interface between the host and the device connected to the host, the method including: transmitting a command message from the host to the device; transmitting a response message from the device to the host in response to the command message; transmitting data between the host and the device; and transmitting an event message from the device to the host when needed.

According to another aspect of the present invention, there is provided a communication method between a host and a device in a communication interface between the host and the device connected to the host, the method including: transmitting a command message from the host to the device, the command message including data expressing a kind of a message, data expressing contents of a message, and additional data; transmitting an event message or transmitting a response message from the device, the response message including data expressing a kind of a message, data expressing contents of a message, and additional data; and transmitting information expressing data and a message including the data between the host and the device in response to the command or the response message when needed.

According to further another aspect of the present invention, there is provided a communication method between a near field communication host and a near field communication device in a communication interface between the host and the device connected to the host, the method including: transmitting a command message from the host to the device, the command message including one of recording data, reading data of the device, requesting the device to transmit predetermined data, and setting the device; transmitting a response message informing a performance result of a relevant command from the device to the host in response to the command message; and transmitting an event message from the device to the host when needed.

### Advantageous Effects

According to the present invention, universality and compatibility in a communication between a host MCU and an NFC device or a chipset are guaranteed.

According to the present invention, universality and compatibility of an interface regarding a command, a response, data, and an event message in a communication between an NFC host and an NFC device or a chipset are guaranteed.

According to the present invention, an NFC device or an NFC chipset can be used without a device driver, a middle ware, or an application modification in an aspect of an NFCH. Also, according to the present invention, universality and compatibility in an interface between a host and an NFC device or an NFC chipset can be achieved even though a driver suitable for each host is not realized in an aspect of the NFC device or the NFC chipset.

### BRIEF DESCRIPTION OF THE DRAWINGS

FIG. 1 is a view illustrating interfaces between various NFCH and various NFC devices or NFC chipsets;

FIG. 2 is a view illustrating disadvantages that can be generated in the case where different interfaces are realized between an NFCH and NFC devices or NFC chipsets;

FIG. 3 is a view explaining a host controller interface concept according to the present invention;

FIG. 4 is a view explaining advantages in the case where a host controller interface according to the present invention is adopted;

FIG. 5 is a view illustrating an exemplary structure of an NFCH and an NFC device according to an embodiment of the present invention;

FIG. 6 is a view illustrating an example of an interface control process in a reader/writer mode according to an embodiment of the present invention;

FIG. 7 is a view illustrating an example of an interface control process in a peer mode according to an embodiment of the present invention;

FIG. 8 is a view illustrating an exemplary method for transmitting data according to an embodiment of the present invention;

FIG. 9 is a view illustrating an example of an interface control process between an NFCH and an NFC device according to an embodiment of the present invention;

FIG. 10 is a view illustrating an exemplary structure of an interface between an NFCH and an NFC chipset (or an NFC device) according to an embodiment of the present invention;

FIG. 11 is a view illustrating another exemplary structure of an interface between an NFCH and an NFC chipset (or an NFC device) according to an embodiment of the present invention;

FIG. 12 is a view illustrating an example of a message format according to an embodiment of the present invention;

FIG. 13 is a view illustrating an example of a message descriptor field (MDESC) in a message format according to an embodiment of the present invention;

FIG. 14 is a view illustrating an example of a node address field (NAD) in a message format according to an embodiment of the present invention;

FIG. 15 is a view illustrating an example of a command message format in a message format according to an embodiment of the present invention;

FIG. 16 is a view illustrating an example of a response message format in a message format according to an embodiment of the present invention;

FIG. 17 is a view illustrating an example of an event message format in a message format according to an embodiment of the present invention;

FIG. 18 is a view illustrating an example of a data message format in a message format according to an embodiment of the present invention;

FIG. 19 is a view illustrating an example of a kind of a command message according to an embodiment of the present invention;

FIG. 20 is a view illustrating an example of a kind of a response message according to an embodiment of the present invention;

FIG. 21 is a view illustrating an example of kinds of a command message and a response message according to an embodiment of the present invention;

FIG. 22 is a view illustrating an example of a kind of an event message according to an embodiment of the present invention;

FIG. 23 is a view illustrating an example of device management functionality in command and response messages according to an embodiment of the present invention;

FIG. 24 is a view illustrating an example of NFC data communication functionality in command and response messages according to an embodiment of the present invention;

FIG. 25 is a view illustrating an example of secure element support functionality in command and response messages according to an embodiment of the present invention;

FIG. 26 is a view illustrating an example of an error code message in command and response messages according to an embodiment of the present invention; and

FIG. 27 is a view illustrating an example of an event message according to an embodiment of the present invention.

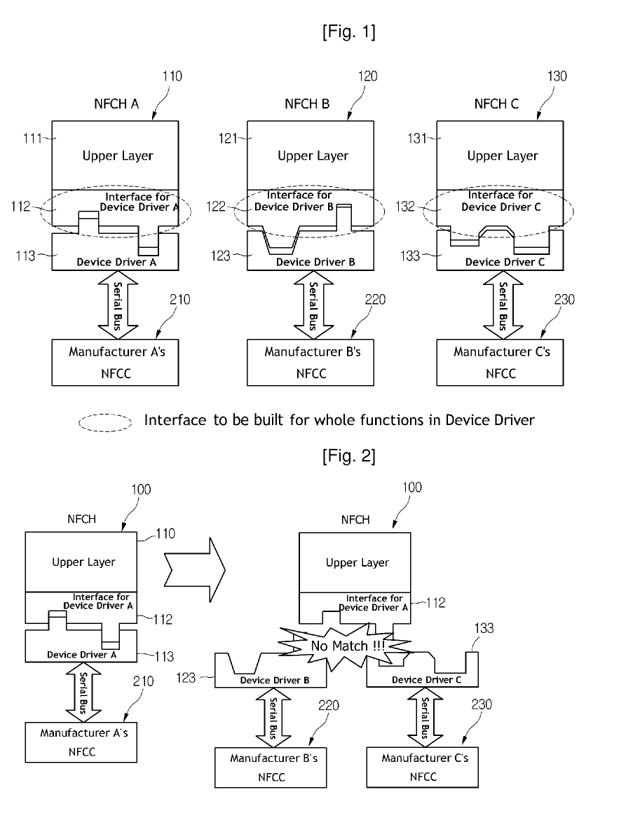

### BEST MODE FOR CARRYING OUT THE INVENTION

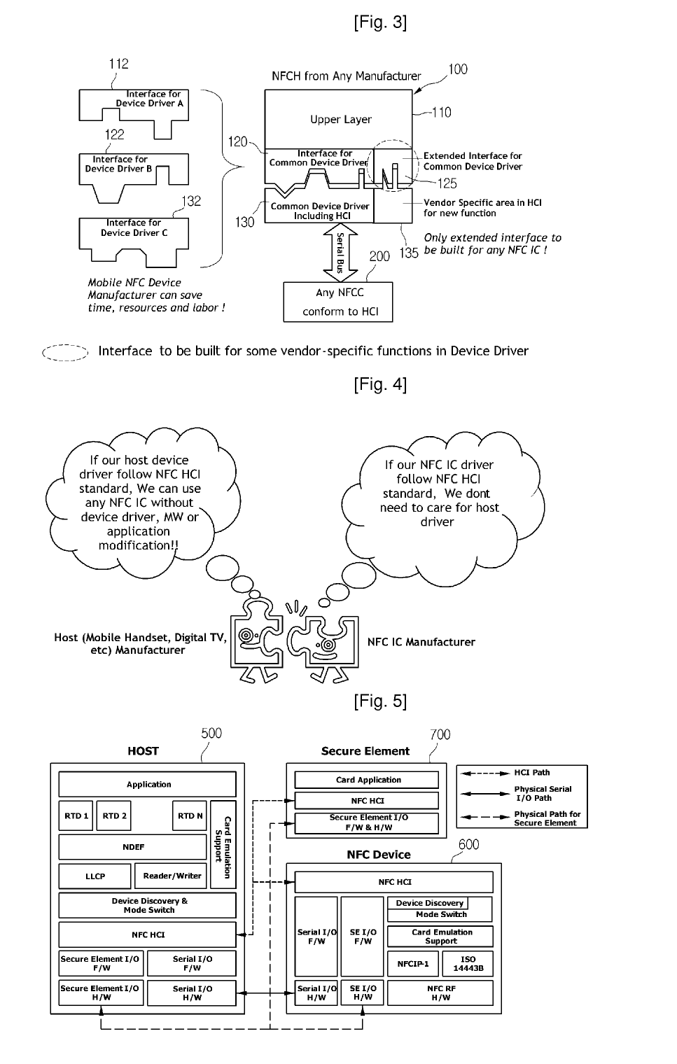

FIG. 3 is a view explaining a host controller interface (HCI) concept according to the present invention. An NFCH, and an NFC chipset or an NFC device conform to a format and a process according to the present invention. According to the present invention, an arbitrary NFCH 100 has a common interface driver 120 with respect to interfaces 112, 122, and 132 corresponding to various kinds of drivers, and an arbitrary NFC chipset (an NFC device is included hereinafter) 200 is connected to a common device driver 130 including the HCI via a communication line, e.g., a serial bus as one embodiment. Also, an extended interface 125 for the common device driver is further provided in order to give extensibility. Accordingly, a driver area 135 that can be freely defined and used by a vendor is further provided.

Referring to FIG. 3, it is possible to guarantee mutual compatibility and universality in a series of control operations including data transmission between different devices by having devices conform to a format and a process determined in association with an interface between an NFCH and an NFC chipset.

FIG. 4 is a view explaining advantages in the case where a host controller interface according to the present invention is adopted. When a host such as a mobile handset and a digital television receiver conforms to an NFC HCI of the present invention, the host can be freely used with compatibility and universality guaranteed without a device driver or a middle ware (MW) with respect to any NFC chipset (NFC IC). Also, when the NFC IC conforms to the NFC HCI, the NFC IC can be freely used with compatibility and universality guaranteed without a difficulty associated with a host driver with respect to any NFC host.

FIG. 5 is a view illustrating an exemplary structure of an NFCH and an NFC device according to an embodiment of the present invention. FIG. 5 illustrates inner structures of a host 500, an NFC device 600, and a secure element 700. The host (i.e., NFCH) 500 includes a logical link control protocol (LLCP), a reader/writer, an NFC data exchange format (NDEF), a card emulation module (e.g., NFCIP-1, ISO 14443B), and a record type definition (RTD) that are located above a device discovery and a mode switch stack. Also, the host 500 further includes respective secure element input/output (I/O) parts (e.g., a secure element I/O firmware (F/W) and a secure element I/O hardware (H/W)), serial input/output (I/O) parts (e.g., a serial I/O firmware (F/W) and a serial I/O hardware (H/W)). And the host 500 is connected to the NFC device 600 and the secure element 700 on the basis of an NFC HCI.

The NFC device 600 is connected to the host 500 and the secure element 700 on the basis of the NFC HCI, and connected to the host 500 and the secure element 700 on the basis of a serial I/O part (e.g., a serial I/O F/W and SE I/O F/W and H/W). Also, the NFC device 600 includes a device discovery and a mode switch stack, a card emulation module, and an NFC RF H/W.

The secure element 700 includes a card application, an NFC HCI, a secure element I/O part (e.g., a secure element I/O F/W and H/W) and is connected to the host 500 and the NFC device 600.

Here, the serial I/O F/W controls a serial port such as a universal asynchronous receiver and transmitter (UART) or a universal serial bus (USB). FIG. 5 illustrates an HCI path, a physical serial I/O path, and a physical path for a secure element using dotted lines and a solid line.

A structure of host-device-secure element illustrated in FIG. 5 is a mere example, and an NFC system of the present invention is not limited to an embodiment illustrated herein. Respective inner structures of the above-described host, device, and card-based secure system, physical structures thereof, and a communication method including modules mounted thereon can be more freely designed and modified, and can be easily realized by a person of ordinary skill in the art.

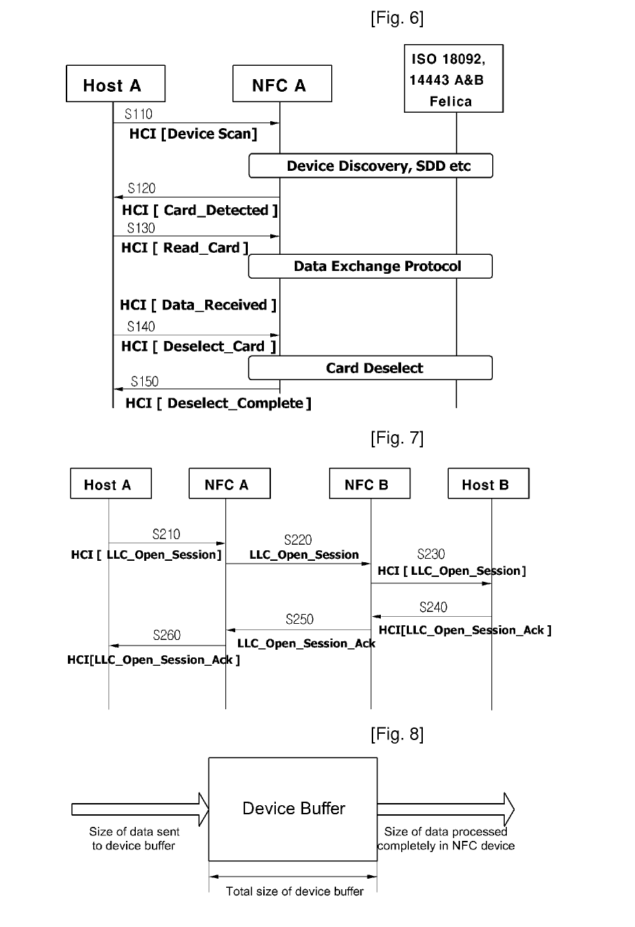

FIG. 6 is a view illustrating an example of an interface control process in a reader/writer mode according to an embodiment of the present invention. FIG. 6 illustrates a process, i.e., a host controller interface (HCI) that can be performed between a host A and an NFC device. The host performs a device scan process on the device (S110). Accordingly, device discovery, single device detection are performed. A card detection response (Card_Detected) therefor is delivered to the host (S120). The host performs a card read process (Read_Card) in response to the card detection (S130). At this point, a data exchange protocol can be applied. Data is received (Data_Received) from the NFC device to the NFCH (S140). When data reception is completed, the host performs a card deselect process (Deselect_Card) (S150). When the card deselect process is completed, the NFC device performs a relevant response (Deselect_Card) on the NFC host (S160).

Referring to FIG. 6, a command and a response operate in a pair in the HCI according to the present invention, which will be described later in detail.

FIG. 7 is a view illustrating an example of an interface control process in a peer mode according to an embodiment of the present invention. That is, FIG. 7 illustrates how the NFC HCI operates in a peer-to-peer communication. A host A and a host B communicate with each other on the basis of an NFC A and an NFC B, respectively. The host A performs a session open (LLC_Open_Session) process on the host B on the basis of the NFC A and NFC B (S210-S230). The host B performs a session open acknowledge (LLC_Open_Session_Ack) process on the host A on the basis of the NFC B and NFC A. That is, the peer-to-peer communication can be freely performed with compatibility and universality guaranteed by conforming to the NFC HCI of the present invention.

FIG. 8 is a view illustrating an exemplary method for transmitting data according to an embodiment of the present invention. Here, the method for transmitting data without a data loss by preventing overflow when transmitting data is illustrated. That is, a data transmission party performs data segmentation and transmits the segmented data and related data to a data reception party with consideration of a size of a device buffer. The data reception party receives the transmitted and segmented data to reconstruct the segmented data, so that the original data can be received without a loss. An example of the related data when the segmented data is transmitted includes data size-related data. Data related to a buffer size of a device in the reception party is obtained during a transmission operation, and data is transmitted using the obtained buffer size-related data.

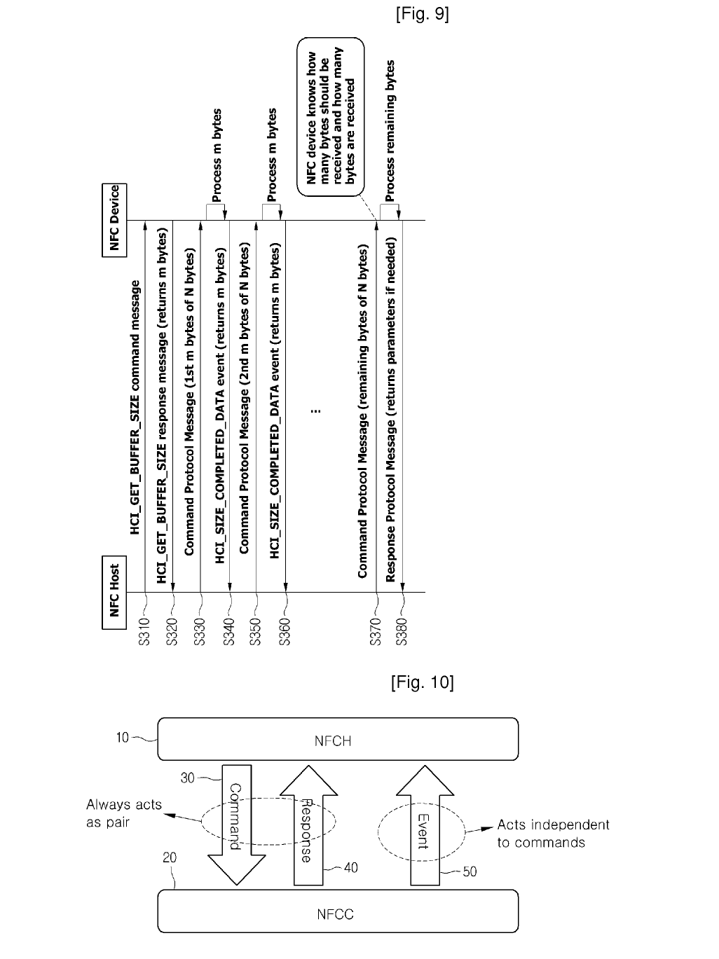

FIG. 9 is a view illustrating an example of an interface control process between an NFCH and an NFC device according to an embodiment of the present invention. That is, FIG. 9 illustrates a series of processes of segmenting data and transmitting the segmented data with consideration of a buffer size of a device, thereby preventing a data loss.

A command (HCI_GET_BUFFER_SIZE command message) requesting a buffer size of a device is delivered from an NFCH to an HFC device (S310).

The NFC device delivers buffer size data (HCI_GET_BUFFER_SIZE response message) expressed by m bytes to the NFCH in response to the command requesting the buffer size of the device (S320). The NFCH transmits first data that has been obtained by segmenting a size of data to be transmitted with consideration of the buffer size (m bytes) on the basis of the buffer size data of the device (Command Protocol Message) (S330). The NFC device transmits a response (HCI_SIZE COMPLETE_DATA event) that the data has been completely received (S340). This response can be performed by returning m bytes. The next operations S350, S360, and S370 describe a process of transmitting the rest data and receiving a response thereof in the same way. When transmission of all data to be transmitted from the NFCH to the NFC device is completed in this manner, the NFC device transmits a message informing that data transmission has been completed to the NFCH, and ends the process (Response Protocol Message). This response can be performed by returning a necessary parameter.

FIG. 10 is a view illustrating an exemplary structure of an interface between an NFCH and an NFC chipset (or an NFC device) according to an embodiment of the present invention. Communication is performed between the NFCH 10 and the NFC device 20 on the basis of a command 30, a response 40, and an event 50. The command 30 is delivered from the NFCH 10 to the NFC device 20. The response 40 is delivered from the NFC device 20 to the NFCH 10. The event 50 is delivered from the NFC device 20 to the NFCH 10, and independent with respect to the command and the response. The command 30 and the response 40 act in a pair. An event process is performed through asynchronous messaging.

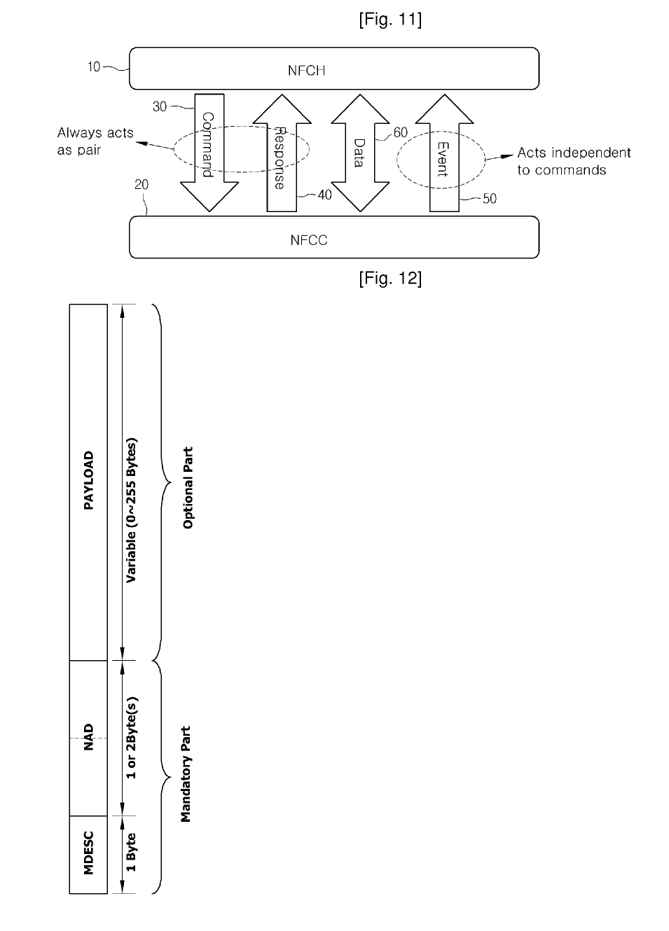

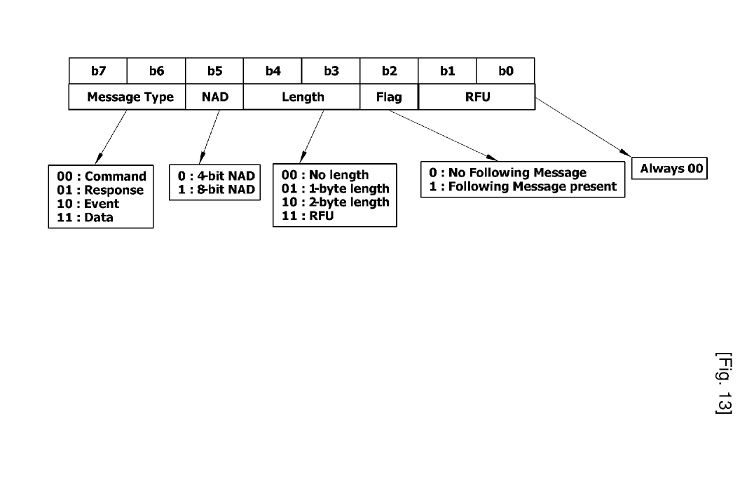

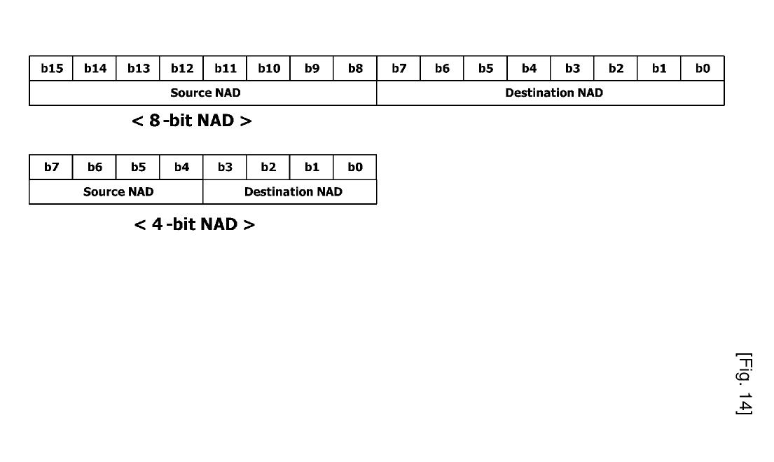

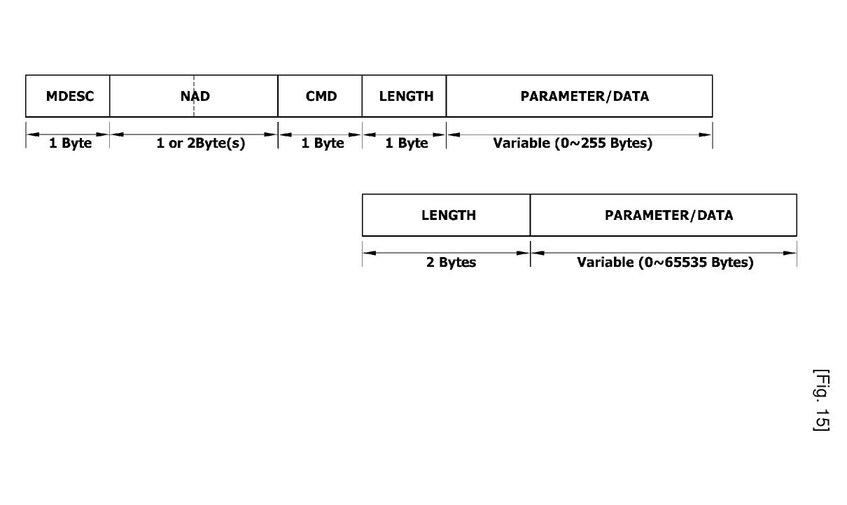

FIG. 11 is a view illustrating another exemplary structure of an interface between an NFCH and an NFC chipset (or an NFC device) according to an embodiment of the present invention. Communication is performed between the NFCH 10 and the NFC device 20 on the basis of a command 30, a response 40, and an event 50. In addition, a data transmission process 60 is provided. The command 30 is delivered from the NFCH 10 to the NFC device 20. The response 40 is delivered from the NFC device 20 to the NFCH 10. The event 50 is delivered from the NFC device 20 to the NFCH 10, and independent with respect to the command and the response. The command 30 and the response 40 act in a pair. An event process is performed through asynchronous messaging. The data 60 is delivered from the NFCH 10 to the NFC device 20, or from the NFC device 20 to the NFCH 10. That is, the data transmission process is based on bi-directional communication. The interface process and the structure thereof illustrated in FIGS. 11 and 12 is a mere example, and the HCI process of the present invention is not limited thereto.

FIG. 12 is a view illustrating an example of a message format according to an embodiment of the present invention. This is just one embodiment, and a message format according to the present invention is not limited thereto. Referring to FIG. 12, a general message format according to an embodiment of the present invention includes a message descriptor field (MDESC), a node address field (NAD), and a payload field. The MDESC field and the NAD field can be considered as a mandatory part, and the payload field can be considered as an optional part. In the message format of FIG. 12, the MDESC has 1 byte, the NAD has 1 byte or 2 bytes, and the payload has 0-255 bytes, but these values are mere examples.

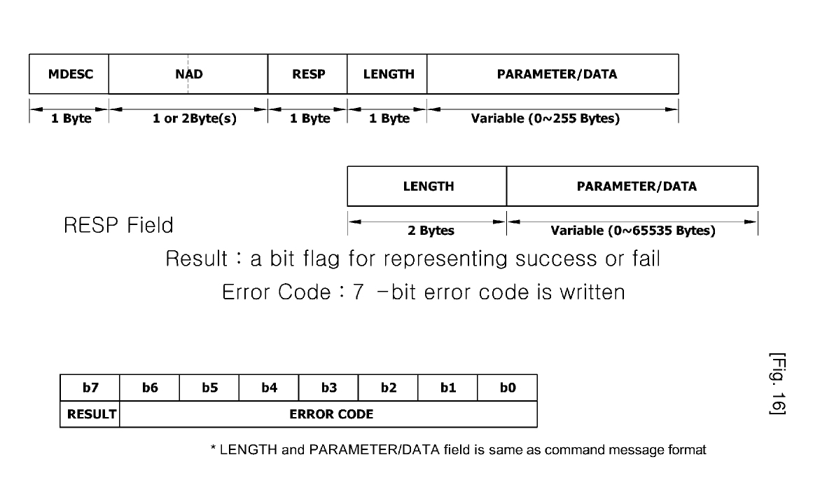

FIG. 13 is a view illustrating an example of a message descriptor field (MDESC) in a message format according to an embodiment of the present invention. Here, FIG. 13 illustrates examples in which what meaning respective values recorded on the MDESC field have in the case where the MDESC is expressed by 1 byte. A message type, an NAD, length data, a flag, and a reserved for future use (RFU) are recorded on the MDESC field. The message type can be expressed by 2 bits, and can express a command, a response, an event, and data depending on the expressed value. The NAD can express whether it is a 4-bit NAD or a 8-bit NAD depending on a value thereof. The length data can express a case where length data is absent (no length), a case where length data is 1 byte long, a case where length data is 2 byte long, and a case where length data is an RFU. The flag can express a case where following message is present and a case where no following message is present. The RFU can be always expressed using a predetermined value.

FIG. 14 is a view illustrating an example of a node address field (NAD) in a message format according to an embodiment of the present invention. The NAD has considered a case where it is a 8-bit NAD and a case where it is a 4-bit NAD. In the case where it is a 8-bit NAD, the NAD can be expressed by 2 bytes in which a source NAD is expressed on an upper 1 byte and a destination NAD is expressed on a lower 1 byte. In the case where it is a 4-bit NAD, the NAD can be expressed by 1 byte in which a source NAD is expressed on upper 4 bits and a destination NAD is expressed on lower 4 bits.

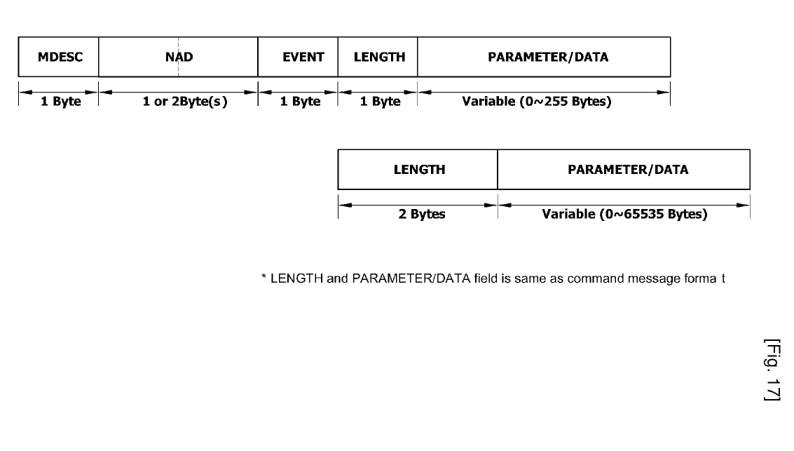

FIG. 15 is a view illustrating an example of a command message format in a message format according to an embodiment of the present invention. The command message format includes an MDESC of 1 byte, an NAD of 1 byte or 2 bytes, a command (CMD) of 1 byte, a length of 1 byte, and a parameter/data of 0-255 bytes. A command code is recorded on a CMD field. In the case where there exists a parameter or data, a length field expresses a length of the parameter or the data. The length can be expressed by 2 bytes. In this case, a length of a parameter or data field can be 0-65535 bytes. A code expressing a command expressed by a message is recorded on the CMD field. Examples of kinds of commands and code values that can be used will be descried later in detail.

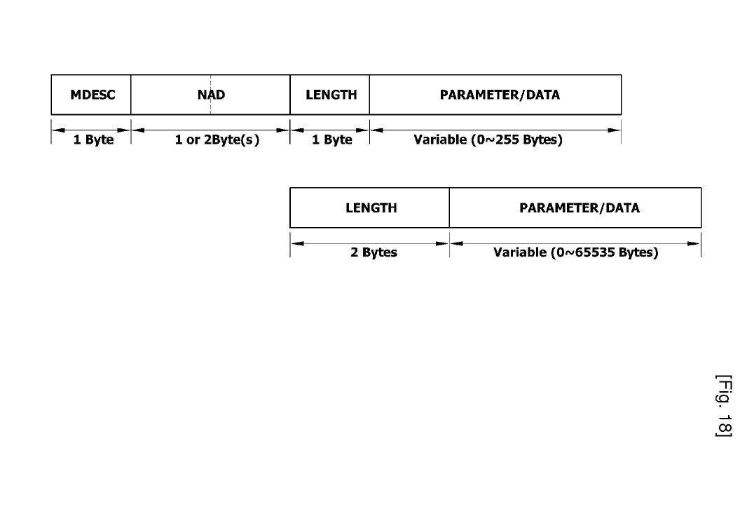

FIG. 16 is a view illustrating an example of a response message format in a message format according to an embodiment of the present invention. The response message format includes an MDESC of 1 byte, an NAD of 1 byte or 2 bytes, a response (RESP) of 1 byte, a length of 1 byte, and a parameter/data of 0-255 bytes. A response code is recorded on a RESP field. In the case where there exists a parameter or data, a length field expresses a length of the parameter or the data. The length can be expressed by 2 bytes. In this case, a length of a parameter or data field can be 0-65535 bytes. A code expressing a response expressed by a message is recorded on the RESP field. A 1-bit flag expressing a success or a failure of a response is expressed as a result. A 7-bit error code expressing a kind of an error is recorded. Kinds of a response, code values that can be used, kinds of errors, and values that can be used will be described later in detail.

FIG. 17 is a view illustrating an example of an event message format in a message format according to an embodiment of the present invention. The event message format includes an MDESC of 1 byte, an NAD of 1 byte or 2 bytes, an event of 1 byte, a length of 1 byte, and a parameter/data of 0-255 bytes. An event code is recorded on an event field. In the case where there exists a parameter or data, a length field expresses a length of the parameter or the data. The length can be expressed by 2 bytes. In this case, a length of a parameter or data field can be 0-65535 bytes. A code expressing an event expressed by a message is recorded on the event field. Examples of kinds of events and code values that can be used will be described later in detail.

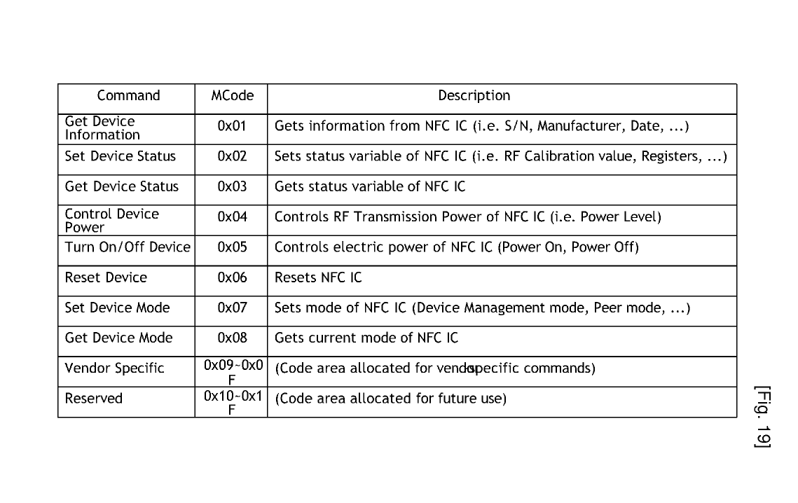

FIG. 18 is a view illustrating an example of a data message format in a message format according to an embodiment of the present invention. The data message format includes an MDESC of 1 byte, an NAD of 1 byte or 2 bytes, a length of 1 byte, and a parameter/data of 0-255 bytes. In the case where there exists a parameter or data, a length field expresses a length of the parameter or the data. The length can be expressed by 2 bytes. In this case, a length of a parameter or data field can be 0-65535 bytes.

FIG. 19 is a view illustrating an example of a kind of a command message according to an embodiment of the present invention. Kinds of a command message and code values expressing relevant commands used therein are mere examples and the present invention is not limited thereto. A Get Device Information command is a command reading data of an NFC device. The Get Device Information command reads a serial number of an NFC device, manufacturer-related data, and manufacturing date. Here, an example of a code value of the Get Device Information command is expressed by 0x01. A Set Device Status command is a command setting a status variable of an NFC device, and sets a radio frequency (RF)-related information (e.g., RF calibration) and registers data. Here, an example of a code value of the Set Device Status command is expressed by 0x02. A Get Device Status command is a command reading a status variable of an NFC device. A code value of the Get Device Status command is expressed by 0x03. A Control Device Power command is a command controlling RF transmission power of an NFC device. A code value of the Control Device Power command is expressed by 0x04. A Turn On/Off Device command is a command turning on or off electrical power of an NFC device. A code valued of the Turn On/Off Device command is expressed by 0x05.

A Reset Device command is a command initializing an NFC device. A code value of the Reset Device command is expressed by 0x06. A Set Device Mode command is a command setting an NFC device mode. For example, the Set Device Mode command sets a device management mode and a peer mode. A code value of the Set Device Mode command is expressed by 0x07. A Get Device Mode command is a command reading a current mode of an NFC device. A code value of the Get Device Mode command is expressed by 0x08.

Meanwhile, a command code area (vendor specific: 0x09-0x0F) that can be defined by a vendor is assigned from a command message, and 0x10-0x1F is assigned as a reserved code area.

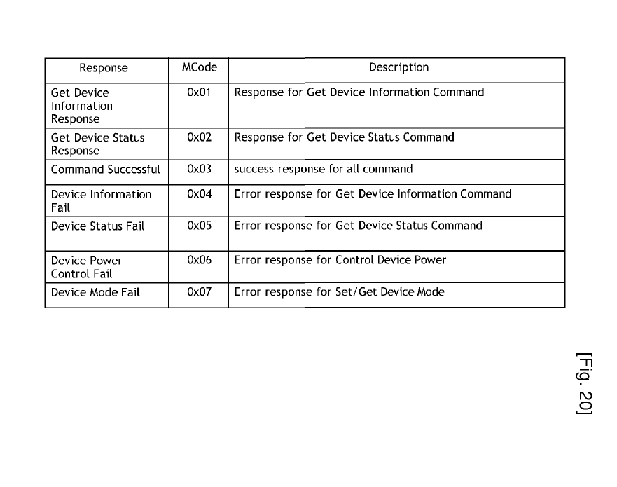

FIG. 20 is a view illustrating an example of a kind of a response message according to an embodiment of the present invention. Kinds of a response message and code values expressing responses used therein are mere examples and the present invention is not limited thereto. A Get Device Information Response is a response to a Get Device Information Command, and a code value of the Get Device Information Response is expressed by 0x01. A Get Device Status Response is a response to a Get Device Status Command, and a code value of the Get Device Status Response is expressed by 0x02. When a command is performed successfully, a response is made by expressing a response informing that the command is successful using a relevant code value of 0x03.

Besides this, a variety of error responses are performed. When an error for the Get Device Information Command is generated, a response is made by expressing a response message informing device information fail using a code value of 0x04. When an error for the Get Device Status Command is generated, a response is made by expressing a response message informing device status fail using a code value of 0x05. When an error for Control Device Power is generated, a response is made by expressing a response message informing device power control fail using a code value of 0x06. When an error for Set/Get Device Mode is generated, a response is made by expressing a response message informing device mode fail using a code value of 0x07.

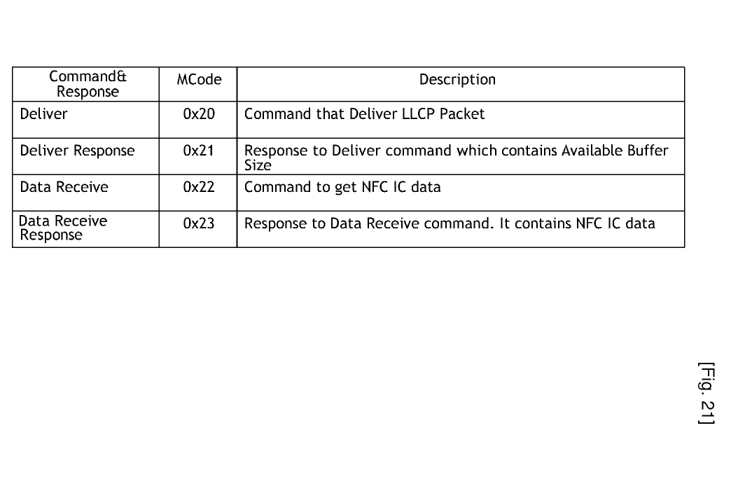

FIG. 21 is a view illustrating an example of kinds of a command message and a response message according to an embodiment of the present invention. Kinds of command messages and response messages and code values expressing commands and responses used therein are mere examples and the present invention is not limited thereto. Here, Deliver describes it is a command that delivers an LLCP packet and uses a code value of 0x02. A Deliver Response is a response that delivers a command having effective buffer size data and uses a code value of 0x21. A Data Receive is a command that reads data from an NFC device and uses a code value of 0x22. A Data Receive Response is a response to a data receiving command, includes NFC device data, and can use a code value of 0x23.

FIG. 22 is a view illustrating an example of a kind of an event message according to an embodiment of the present invention. An event message is independent with respect to a command and a response. When data reception or a critical error is generated at an NFC device, an event message is used to inform the generated event to an NFCH. Here, some representative cases are descried. Three event messages of HCI Bus Driver Fail, NFC IC Has Data, and Buffer Available are described. Each message uses a corresponding code of 0x01, 0x02, and 0x03 expressing a corresponding event. In the case where a problem is generated to an HCI bus driver, an NFC device receives data from an RF module, or a buffer size changes, these messages can be used for providing corresponding data. Detailed description of each case is made in FIG. 22.

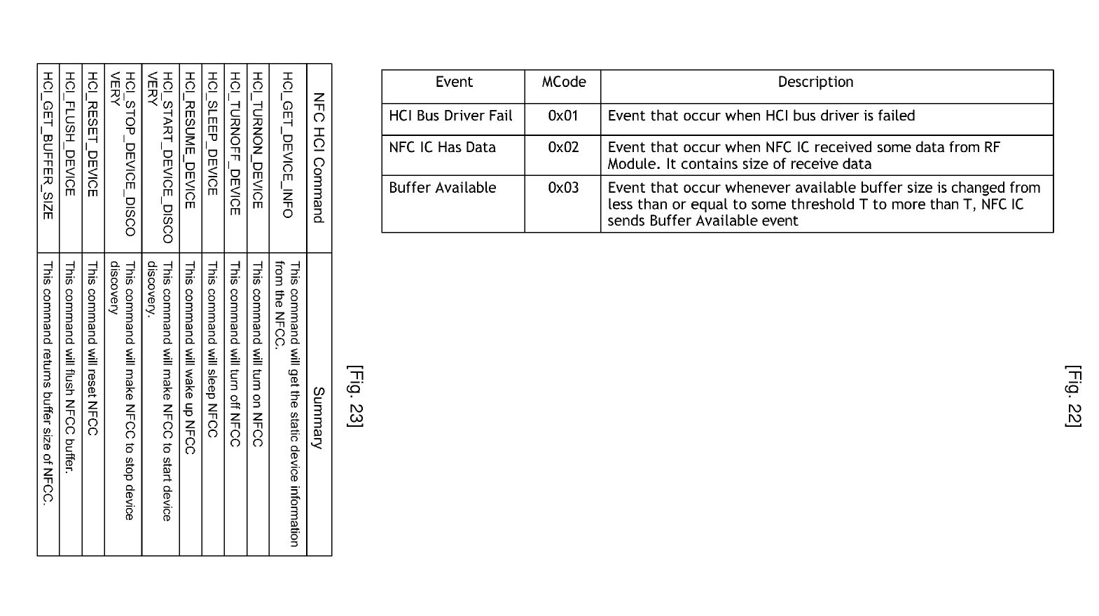

FIG. 23 is a view illustrating an example of device management functionality in command and response messages according to an embodiment of the present invention. This corresponds to a device management category. A command HCI_GET_DEVICE_INFO is a command reading NFC device data, and a message type is a command. A code value of the command HCI_GET_DEVICE_INFO, and a command parameter and a return parameter value as parameters are recorded.

A command HCI_TURNON_DEVICE is a command for turning on power of an NFC device, and a message type is a command. A code value of the command HCI_TURNON_DEVICE and a return parameter value expressing a success or a failure are recorded.

A command HCI_TURNOFF DEVICE is a command for turning off power of an NFC device, and a message type is a command. A code value of the command HCI_TURNOFF_DEVICE and a return parameter value expressing a success or a failure are recorded.

A command HCI_SLEEP_DEVICE is a command for changing an NFC device to a sleep state, and a message type is a command. A code value of the command HCI_SLEEP_DEVICE and a return parameter value expressing a success or a failure are recorded.

A command HCI_RESUME DEVICE is a command for waking up an NFC device from a sleep state, and a message type is a command. A code value of the command HCI_RESUME_DEVICE and a return parameter value expressing a success or a failure are recorded.

A command HCI_START_DEVICE_DISCOVERY is a command for starting NFC device discovery, and a message type is a command. A code value of the command HCI_START_DEVICE_DISCOVERY and a return parameter value expressing a success or a failure are recorded.

A command HCI_STOP_DEVICE_DISCOVERY is a command for stopping NFC device discovery, and a message type is a command. A code value of the command HCI_STOP_DEVICE_DISCOVERY and a return parameter value expressing a success or a failure are recorded.

A command HCI_RESET_DEVICE is a command for initializing an NFC device, and a message type is a command. A code value of the command HCI_RESET_DEVICE and a return parameter value expressing a success or a failure are recorded.

A command HCI_FLUSH_DEVICE is a command for flushing an NFC device buffer, and a message type is a command. A code value of the command HCI_FLUSH_DEVICE and a return parameter value expressing a success or a failure are recorded.

A command HCI_GET_BUFFER_SIZE is a command for reading an NFC device buffer size, and a message type is a command. A code value of the command HCI_GET_BUFFER_SIZE and a return parameter value expressing a success or a failure and a buffer size are recorded.

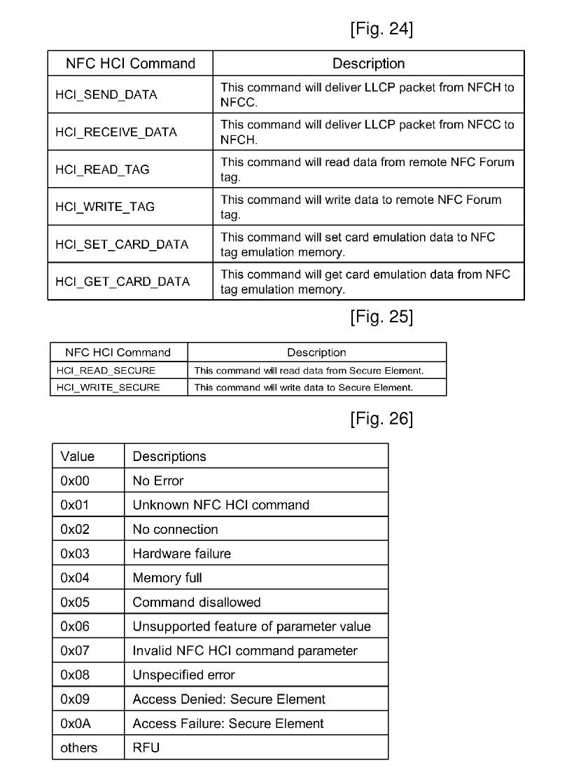

FIG. 24 is a view illustrating an example of NFC data communication functionality in command and response messages according to an embodiment of the present invention. This corresponds to an NFC data communication category.

A command HCI_SEND_DATA is a command for delivering an LLCP packet from an NFCH to an NFC device, and a message type of this command HCI_SEND_DATA is a command. A code value of the command HCI_SEND_DATA, a command parameter expressing an LLCP packet, and a return parameter value expressing a success or a failure and a buffer size are recorded.

A command HCI_RECEIVE_DATA is a command for delivering an LLCP packet from an NFC device to an NFCH, and a message type of this command HCI_RECEIVE_DATA is a command. A code value of the command HCI_RECEIVE_DATA, a command parameter expressing an LLCP packet, and a return parameter value expressing a success or a failure and a buffer size are recorded.

A command HCI_READ_TAG is a command for reading NFC data exchange format (NDEF) data from an NFC forum tag of the NFC device, and a message type of this command HCI_READ_TAG is a command. A code value of the command HCI_READ_TAG, and a return parameter value expressing a success or a failure are recorded. Also, a read_data parameter (a command parameter) is recorded. This read_data parameter is read from an NFC forum tag, and thus this data format conforms to an NDEF.

A command HCI_WRITE_TAG is a command for recording NDEF data on an NFC forum tag of the NFC device, and a message type of this command HCI_WRITE_TAG is a command. A code value of the command HCI_WRITE_TAG, and a return parameter value expressing a success or a failure are recorded. Also, a write_data parameter (a command parameter) is recorded. This write_data parameter includes NDEF data to be recorded on a tag.

A command HCI_SET_CARD_DATA is a command for recording NDEF data in a card memory of an NDEF device in order to perform card emulation, and a message type of this command HCI_SET_CARD_DATA is a command. A code value of the command HCI_SET_CARD_DATA, and a return parameter value expressing a success or a failure are recorded. Also, a card_data parameter is recorded as a command parameter. This card_data parameter expresses data to be stored in a card emulation memory.

A command HCI_GET_CARD_DATA is a command for reading data stored in a card memory of the NFC device, and a message type of this command HCI_GET_CARD_DATA is a command. A code value of the command HCI_GET_CARD_DATA, and a return parameter value expressing a success or a failure are recorded. Also, a card_data parameter is recorded.

In the above, the parameter value expressing a failure in the above-described message format can be accompanied with a corresponding error code value.

FIG. 25 is a view illustrating an example of secure element support functionality in command and response messages according to an embodiment of the present invention. That is, FIG. 25 illustrates HCI_READ_SECURE which is a command for reading data from a secure element, and HCI_WRITE_SECURE, which is a command for recording data on a secure element.

FIG. 26 is a view illustrating an example of an error code message in command and response messages according to an embodiment of the present invention. Kinds of errors and code values expressing the errors used therein are mere examples and the present invention is not limited thereto. Error code values and meanings thereof according to an embodiment of the present invention are described. 0x00 expresses no error is present, 0x01 expresses an undefined command, 0x02 expresses connection between devices is not made, and 0x03 expresses a hardware failure.

Also, 0x04 expresses a memory full state, 0x05 expresses a command disallowed, 0x06 expresses a parameter value is not supported, and 0x07 expresses an invalid command parameter.

Also, 0x08 expresses error not prescribed, 0x09 expresses an access of a secure element has been rejected, and 0x0A expresses an access of a secure element has failed. The rest code value is RFU.

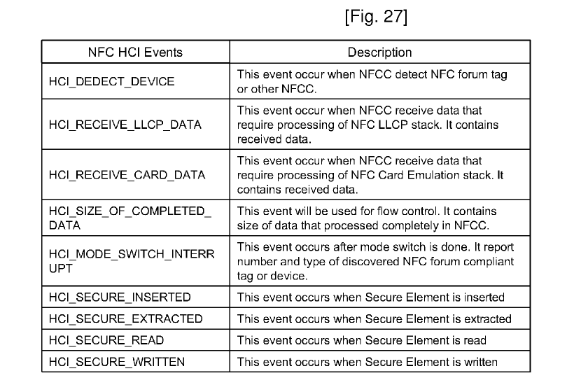

FIG. 27 is a view illustrating an example of an event message according to an embodiment of the present invention. Kinds of event messages used therein are mere examples and the present invention is not limited thereto.

HCI_DETECT_DEVICE is an event message informing a host that the number of detected devices or tags of a predetermined type when device discovery is performed, and a message type of HCI_DETECT_DEVICE is an event. A corresponding message code is recorded.

HCI_RECEIVE_DATA_EVENT is an event message for delivering data to a host when an NFC device receives the data from an air interface, and a message type of HCI_RECEIVE_DATA_EVENT is an event. A corresponding message code, and a receive_data parameter as a return parameter are recorded. A receive_data parameter is an NFC forum tag required for NFC protocol processing or data from a device.

HCI_SIZE_OF_COMPLETED_DATA is an event message for informing, at an NFC device, an NFCH of a size of completely processed data to perform flow control. How frequently this event message is to be sent is not particularly determined. This message type is an event. A corresponding message code, and a data_size parameter as a return parameter are recorded. A data_size parameter expresses a size of data processing-completed by an NFC device.

HCI_MODE_SWITCH_INTERRUPT is an interrupt event for informing a host of an NFC tag or a device when the NFC tag or the device is found at a mode switch, and a message type of HCI_MODE_SWITCH_INTERRUPT is an event. A corresponding message code, and a device_type as a return parameter are recorded. A device_type is a parameter expressing an NFC device or a card when the NFC device or the card is found. For example, 0x00 expresses ISO14443-A card only, 0x01 expresses ISO14443-B card only, 0x02 expresses Felica card only, 0x03 expresses ISO14443-A and B, 0x04 expresses ISO14443-A and Felica, 0x05 expresses Felica and ISO14443-B, and 0x06 expresses ISO14443-A and B and Felica and is assigned a code value for RFU.

HCI_SECURE_INSERTED expresses a secure element has been inserted, HCI_SECURE_EXTRACTED expresses a secure element has been extracted, HCI_SECURE_READ expresses reading a secure element, and HCI_SECURE_WRITTEN expresses recording a secure element.

Up to now, an NFC HCI according to an embodiment of the present invention has been descried. Kinds, formats, code values of an HCI system, and a process for transmitting a message described herein and illustrated in the drawings are mere embodiments taken as examples for understanding of the present invention. Various modifications and changes of the kinds, formats, code values thereof, and the process for transmitting the message may be realized on the basis of the embodiments within the scope of the present invention. Also, terms used in the embodiments of the present invention is intended for understanding purpose only, and the present invention is not limited thereto.

### INDUSTRIAL APPLICABILITY

The present invention is applied to an HCI between an NFCH and an NFC chipset or an NFC device.

1. A communication method between a host and a device in a communication interface between the host and the device connected to the host, the method comprising:
transmitting a command message from the host to the device;
transmitting a response message from the device to the host in response to the command message;
transmitting data between the host and the device; and
transmitting an event message from the device to the host when needed.

2. The method according to claim 1, wherein the command message and the response message are transmitted in a pair of a command and a response thereto.

3. The method according to claim 1, wherein the event message is independent with respect to the command message and the response message.

4. The method according to claim 1, wherein the message conforms to a process of transmitting/receiving the message to/from a device using a corresponding device driver on the basis of a corresponding device driver interface mounted in the host.

5. The method according to claim 1, wherein the message is transmitted and received on the basis of a device driver interface mounted in a first host and a device driver interface mounted in a second host.

6. The method according to claim 1, wherein data transmitted between the host and the device is segmented by the host depending on a size of a storage space of the device, the segmented data are transmitted using information expressing data segmentation to the device through a plurality of processes, and the transmitted and segmented data are reconstructed by the device.

7. A communication method between a host and a device in a communication interface between the host and the device connected to the host, the method comprising:
transmitting a command message from the host to the device, the command message including data expressing a kind of a message, data expressing contents of a message, and additional data;
transmitting an event message or transmitting a response message from the device, the response message including data expressing a kind of a message, data expressing contents of a message, and additional data; and
transmitting information expressing data and a message including the data between the host and the device in response to the command or response message when needed.

8. The method according to claim 7, wherein the data expressing the kind of the message is expressed using a code value expressing whether a message type of the message is a command, a response, a data, or an event.

9. The method according to claim 7, wherein the data expressing the contents of the message is expressed using a code value expressing what command a corresponding command is, what response a corresponding response is, or what contents of an event a corresponding event is.

10. The method according to claim 7, wherein the command message comprises a command for reading device data or setting device data.

11. The method according to claim 7, wherein the command message comprises a command for controlling power of the device or device power for an air interface.

12. The method according to claim 7, wherein the command message comprises a command for initializing the device, setting a device mode, or reading a device mode.

13. The method according to claim 7, wherein the response message comprises one of a response in response to a device data providing request from the host, and a response in response to a device control command from the host.

14. The method according to claim 7, wherein the response message comprises an error response message.

15. The method according to claim 7, wherein the command message and the response message comprise a response message regarding transmission of a data packet or a transmission result.

16. The method according to claim 7, wherein the event comprises at least one of a bus driver state, data reception by an air interface module, occurrence of a buffer size, detection of a tag or other device, card emulation, a mode switch, installation or removal of a secure element, a read or write event of secure element data.

17. A communication method between a near field communication host and a near field communication device in a communication interface between the host and the device connected to the host, the method comprising:
transmitting a command message from the host to the device, the command message including one of recording data, reading data of the device, requesting the device to transmit predetermined data, and setting the device;
transmitting a response message informing a performance result of a relevant command from the device to the host in response to the command message; and
transmitting an event message from the device to the host when needed.

18. The method according to claim 17, wherein the command and response message comprises at least one of a command for reading data of the device and a response thereof, a command for turning on/off the device and a response thereof, a command for changing the device into a sleep mode or waking up the device and a response thereof, a command for starting detection of the device or stopping detection of the device and a response thereof, a command for initializing the device and a response thereof, a device buffer flush command and a response thereof, a device buffer size return command and a response thereof, a command for transmitting from the host or receiving data from the device and a response thereof, a tag data read/write command and a response thereof, and a command for setting or reading card emulation data of a near field communication tag emulation storage device and a response thereof.

19. The method according to claim 17, wherein the response message comprises data expressing a success or a failure with respect to performance of a command, and data expressing contents of the failure when the command has failed.

20. The method according to claim 17, wherein the host is a processor of a mobile device.
